(19) United States
(12) Patent Application Publication
(10) Pub. No.: US 2014/0141402 A1
(43) Pub. Date: May 22, 2014

(54) INFORMATION PROVISION DEVICE, INFORMATION PROVISION METHOD, INFORMATION PROVISION PROGRAM, AND COMPUTER-READABLE RECORDING MEDIUM FOR RECORDING THE PROGRAM

(71) Applicant: Tadahiro Yamamoto, Shinagawa-ku (JP)

(72) Inventor: Tadahiro Yamamoto, Shinagawa-ku (JP)

(73) Assignee: RAKUTEN, INC., Shinagawa-ku, Tokyo (JP)

(21) Appl. No.: 14/232,451

(22) PCT Filed: Aug. 31, 2012
(86) PCT No.: PCT/JP2012/072192

§ 371 Date: Jan. 13, 2014

(30) Foreign Application Priority Data
Dec. 28, 2011 (JP) 2011-288917

(51) Int. Cl. G09B 7/00

(52) U.S. Cl. CPC G09B 7/00
USPC 434/362

(57) ABSTRACT

An information providing server includes a presentation request reception unit, a selection unit, a transmission unit, an answer reception unit, a storage unit and an updating unit. The presentation request reception unit receives a presentation request for a question requiring an answer from a terminal of a user. The selection unit selects one or more questions. The storage unit stores answer information in which a user ID, question IDs, and an answer status are associated, in an answer information storage unit, at a timing at which the questions selected by the selection unit are transmitted to the terminal if the user. Further, the selection unit extracts the answer information which includes the user ID and in which the answer status is unanswered, from the answer information storage unit, and selects questions corresponding to the question IDs of the extracted answer information as one or more questions.

### TECHNICAL FIELD

An aspect of the present invention relates to information providing device, method and program which present a question requiring an answer, and a computer-readable recording medium having the program recorded thereon.

### BACKGROUND ART

Conventionally, a mechanism for selecting one question from among a plurality of questions and presenting the question to a user in response to a request of the user is known. For example, providing a quiz or a questionnaire as advertisement information, determining whether a premium can be provided and content of a providing premium according to content of an answer to the quiz or the questionnaire, and providing premium providing information according to determination content is described in Patent Document 1 below.

### CITATION LIST

### Patent Literature

[Patent Document 1] Japanese Patent Laid-Open Publication No. 2003-242401

### SUMMARY OF INVENTION

### Technical Problem

Incidentally, when one or more questions from a plurality of questions are presented from a server to a user terminal, inappropriate questions are likely to be presented to a user due to lost communication, an intentional manipulation of the user or the like. For example, when an answer is not received by the server due to lost communication or the like when the user tries to answer a question, and the user tries to answer the question again, the same question may not be displayed. Further, the user performing an illegal act of sending a request to the server several times until an answerable quiz is displayed by the same question not being displayed is considered.

Therefore, it is necessary to present a next appropriate question based on an answer status of a user.

### Solution to Problem

An information providing device according to an aspect of the present invention includes a presentation request reception unit which receives a presentation request for a question requiring an answer from a terminal of a user; a selection unit which selects one or more questions from a question information storage unit which stores question information relating to a plurality of questions, each piece of question information including one question and a question ID for identifying the question; a transmission unit which transmits the one or more questions selected by the selection unit to the terminal; an answer reception unit which receives answers to the one or more questions transmitted by the transmission unit from the terminal; a storage unit which stores answer information in which a user ID for identifying the user, one or more question IDs corresponding to the one or more questions, and an answer status indicating presence or absence of the answers to the one or more questions are associated, in an answer information storage unit, at a timing at which the questions selected by the selection unit are transmitted to the terminal of the user; and an updating unit which updates the answer status associated with the user ID for identifying the user and the question ID into an answered state at a timing at which the answers to the transmitted one or more questions are received from the terminal of the user, wherein the selection unit extracts the answer information which includes the user ID and in which the answer status is Unanswered, from the answer information storage unit, and selects question corresponding to the question IDs of the extracted answer information as next one or more questions.

An information providing method according to an aspect of the present invention includes a presentation request reception step of receiving a presentation request for a question requiring an answer from a terminal of a user; a selection step of selecting one or more questions from a question information storage unit which stores question information relating to a plurality of questions, each piece of question information including one question and a question ID for identifying the question; a transmission step of transmitting the one or more questions selected in the selection step to the terminal; an answer reception step of receiving answers to the one or more questions transmitted in the transmission step from the terminal; a storage step of storing answer information in which a user ID for identifying the user, one or more question IDs corresponding to the one or more questions, and an answer status indicating presence or absence of the answers to the one or more questions are associated, in an answer information storage unit, at a timing at which the questions selected in the selection step are transmitted to the terminal of the user; and an updating step of updating the answer status associated with the user ID for identifying the user and the question ID into an answered state at a timing at which the answers to the transmitted one or more questions are received from the terminal of the user, wherein, in the selection step, the answer information which includes the user ID and in which the answer status is Unanswered is extracted from the answer information storage unit, and questions corresponding to the question IDs of the extracted answer information are selected as next one or more questions.

An information providing program according to an aspect of the present invention causes a computer to function as: a presentation request reception unit which receives a presentation request for a question requiring an answer from a terminal of a user; a selection unit which selects one or more questions from a question information storage unit which stores question information relating to a plurality of questions, each piece of question information including one question and a question ID for identifying the question; a transmission unit which transmits the one or more questions selected by the selection unit to the terminal; an answer reception unit which receives answers to the one or more questions transmitted by the transmission unit from the terminal; a storage unit which stores answer information in which a user ID for identifying the user, one or more question IDs corresponding to the one or more questions, and an answer status indicating presence or absence of the answers to the one or more questions are associated, in an answer information storage unit, at a timing at which the questions selected by the selection unit are transmitted to the terminal of the user; and an updating unit which updates the answer status associated with the user ID for identifying the user and the question ID into an answered state at a timing at which the answers to the transmitted one or more questions are received from the terminal of the user, wherein the selection unit extracts the answer information which includes the user ID and in which the answer status is Unanswered, from the answer information storage unit, and selects question corresponding to the question IDs of the extracted answer information as next one or more questions.

A computer-readable recording medium according to an aspect of the present invention is a computer-readable recording medium having an information providing program recorded thereon, wherein the information providing program causes a computer to function as: a presentation request reception unit which receives a presentation request for a question requiring an answer from a terminal of a user; a selection unit which selects one or more questions from a question information storage unit which stores question information relating to a plurality of questions, each piece of question information including one question and a question ID for identifying the question; a transmission unit which transmits the one or more questions selected by the selection unit to the terminal; an answer reception unit which receives answers to the one or more questions transmitted by the transmission unit from the terminal; a storage unit which stores answer information in which a user ID for identifying the user, one or more question IDs corresponding to the one or more questions, and an answer status indicating presence or absence of the answers to the one or more questions are associated, in an answer information storage unit, at a timing at which the questions selected by the selection unit are transmitted to the terminal of the user; and an updating unit which updates the answer status associated with the user ID for identifying the user and the question ID into an answered state at a timing at which the answers to the transmitted one or more questions are received from the terminal of the user, wherein the selection unit extracts the answer information which includes the user ID and in which the answer status is Unanswered, from the answer information storage unit, and selects question corresponding to the question IDs of the extracted answer information as next one or more questions.

According to such aspects, since the next one or more questions are selected based on the answer information in which a question presented to the user and the answer status for the question are associated, it is possible to present appropriate next questions based on the question status of the user. For example, when an answer is not received by the server due to lost communication or the like when the user tries to answer a certain question, and the user tries to answer the question again, the same question not answered by the user is displayed. Further, since the same question is presented as long as the question is not answered, it is possible to prevent an illegal act of sending a request to the server several times until an answerable quiz is displayed.

In the information providing device according to another aspect, a batch processing execution unit which deletes the answer information stored in the answer information storage unit on predetermined execution date and time may be further included, date and time on which answers to the one or more questions are received may be further associated as answer date and time in the answer information, and when the answer information which corresponds to the user ID and in which date and time on which the answer has been received is within a predetermined time before the execution date and time is stored in the answer information storage unit, the batch processing execution unit may not delete the answer information for the user ID.

In this case, when the user answers after a time point obtained by going back a predetermined period of time from execution date and time of a deletion process, the answer information for the user is held instead of being deleted. Therefore, it is possible to prevent a situation in which the associated answer information is deleted while the quiz is being answered.

In the information providing device according to yet another aspect, the answer date and time may be date and time on which the answers to the one or more questions initially transmitted to the terminal among the plurality of questions are received. In this case, it is also possible to delete or hold the answer information in consideration of a timing at which a user begins to answer to the question.

In the information providing device according to yet another aspect, the answer date and time may be date and time on which the answer to the one or more questions last transmitted to the terminal among the plurality of questions are received. In this case, it is also possible to delete or hold the answer information in consideration of a timing at which a user has last answered to the question.

In the information providing device according to yet another aspect, the batch processing execution unit may delete the answer information for the user ID which has not been deleted on the execution date and time when a predetermined time elapses from the execution date and time. In this case, it is possible to delete all answer information without giving a disadvantage to a user.

### Advantageous Effects of Invention

According to an aspect of the present invention, it is possible to present the next question based on the question status of the user.

### BRIEF DESCRIPTION OF DRAWINGS

FIG. 1 is a diagram illustrating an entire configuration of an information providing system according to an embodiment;

FIG. 2 is a block diagram illustrating a functional configuration of an information providing server illustrated in FIG. 1;

FIG. 3 is a diagram illustrating a hardware configuration of the information providing server illustrated in FIG. 1;

FIG. 4 is a diagram illustrating an example of question information stored in a question information storage unit;

FIG. 5 is a diagram illustrating an example of answer information stored in an answer information storage unit;

FIG. 6 is a diagram illustrating an example of batch processing in a batch processing execution unit;

FIG. 7 is a diagram illustrating another example of the batch processing in the batch processing execution unit.

FIG. 8 is a sequence diagram illustrating a process relating to a question to a user and reception of an answer;

FIG. 9 is a flowchart illustrating batch processing; and

FIG. 10 is a diagram illustrating a configuration of an information providing program according to an embodiment.

### DESCRIPTION OF EMBODIMENTS

Hereinafter, embodiments of the present invention will be described in detail with reference to the accompanying drawings. In the present embodiment, an information providing device according to the present invention is applied to an information providing server which presents a quiz to a user. Further, the same or equivalent elements are denoted with the same reference signs in a description of the drawings, and a repeated description is omitted.

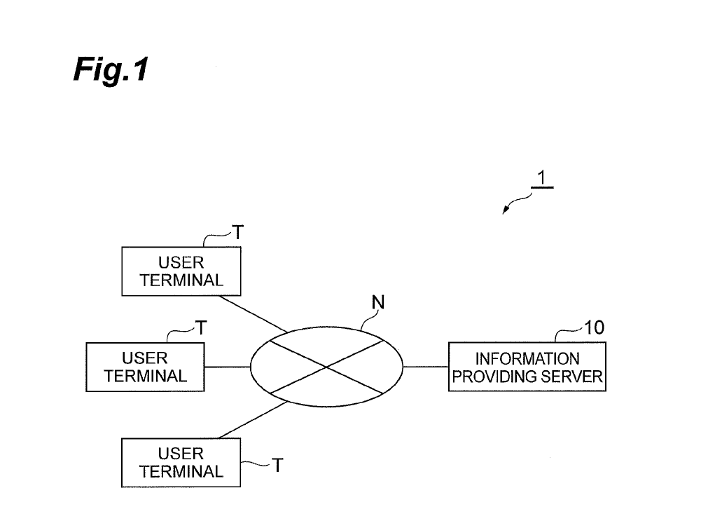

First, an information providing system 1 according to the present embodiment will be described. The information providing server 10 is a computer system which transmits a quiz (a question requiring an answer) to a user terminal T in response to a request from the user terminal T owned by a user. The information providing system 1 includes the information providing server 10 and one or more user terminals T, as illustrated in FIG. 1.

The information providing server 10 is connected to a plurality of user terminals T via a network N. While three user terminals T are illustrated in FIG. 1, there may be any number of user terminals T. Examples of the user terminal T include a computer, a high-performance portable telephone (smartphone) or a personal digital assistant (PDA), but a type of user terminal T is not limited thereto. The network N includes a wired or wireless general-purpose line or a wired or wireless dedicated line, but a configuration of the network N is not limited.

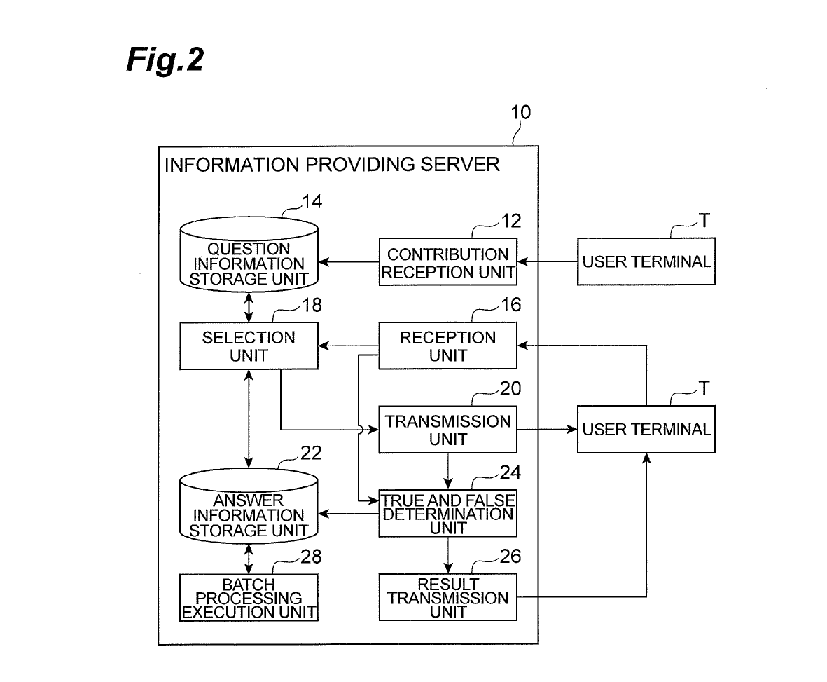

Next, a functional configuration of the information providing server 10 will be described in detail. The information providing server 10 includes a contribution reception unit 12, a question information storage unit 14, a reception unit (presentation request reception unit; answer reception unit) 16, a selection unit 18 (storage unit), a transmission unit 20, an answer information storage unit 22, a true and false determination unit 24 (updating unit), a result transmission unit 26, and a batch processing execution unit 28, as functional components, as illustrated in FIG. 2.

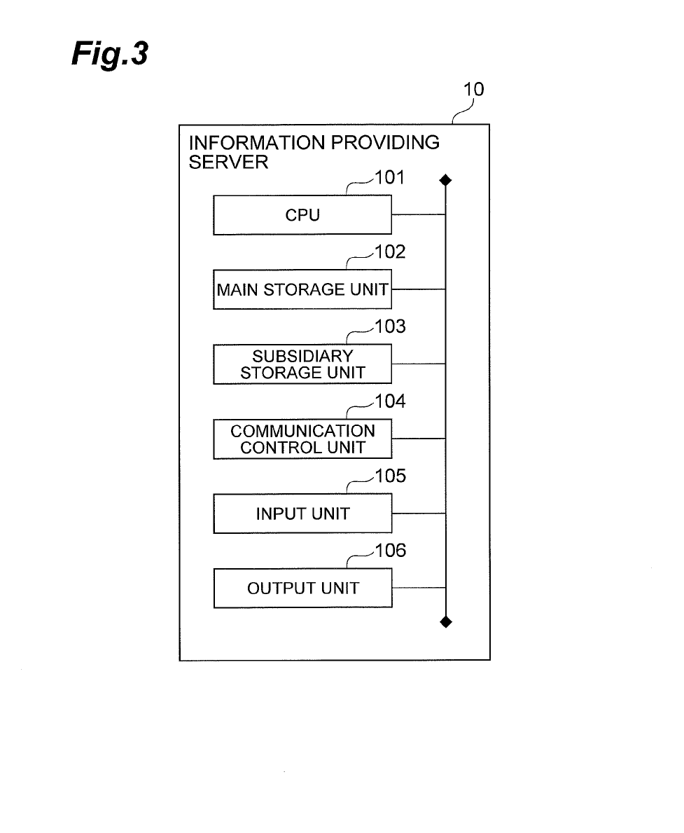

This information providing server 10 includes a CPU 101 which executes an operating system, an application program, or the like, a main storage unit 102 including a ROM and a RAM, a subsidiary storage unit 103 including a hard disk or the like, a communication control unit 104 including a network card or the like, an input unit 105 such as a keyboard or a mouse, and an output unit 106 such as a monitor, as illustrated in FIG. 3. Each function of the information providing server 10 is realized by loading predetermined software on the CPU 101 or the main storage unit 102, operating the communication control unit 104, the input unit 105, the output unit 106 or the like under control of the CPU 101, and performing reading and writing of data in the main storage unit 102 or the subsidiary storage unit 103. Data or a database necessary for processing is stored in the main storage unit 102 or the subsidiary storage unit 103.

Further, while the information providing server 10 is shown as including one computer in FIG. 1, the functions of the information providing server 10 may be distributed to a plurality of computers. For example, the information providing server 10 may include a computer including each storage unit illustrated in FIG. 2, and a computer having other functions.

The contribution reception unit 12 is a means which receives a contribution of a quiz from the user terminal T. The contribution reception unit 12 receives a quiz and a correct answer of the quiz from the user terminal T via the network N. The contribution reception unit 12 generates question information in which a quiz ID (question ID) for identifying the quiz is associated with the quiz and the correct answer received from the user terminal T. The contribution reception unit 12 stores the generated question information in the question information storage unit 14.

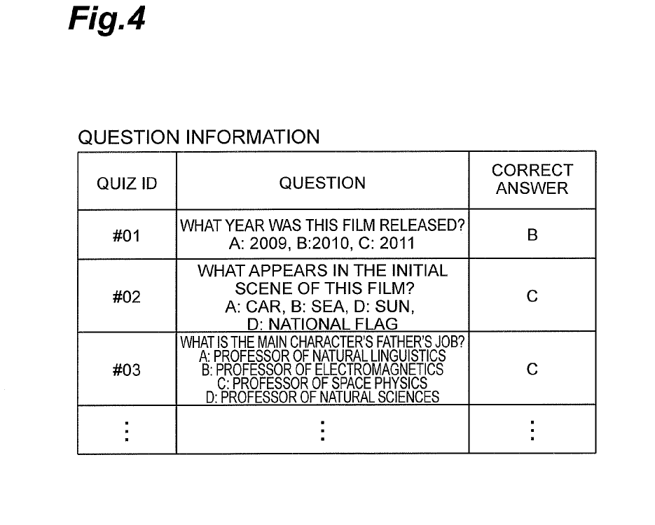

The question information storage unit 14 is a means which stores the question information on the quiz. The question information includes the quiz ID for uniquely identifying the quiz, a question of the quiz, and the correct answer of the quiz, as illustrated in FIG. 4. Hereinafter, a description will be given on the assumption that the question information storage unit 14 stores a plurality of pieces of question information in advance. Further, the question information may be generated by a manager of the information providing system 1 rather than the user and stored in the question information storage unit 14. Further, for the question information, items different from these items may be stored.

The reception unit 16 is a means which receives a quiz presentation request from the user terminal T and receives an answer to a transmitted quiz from the user terminal T. The presentation request is a request for a question of a quiz from the user. The user terminal T transmits, for example, a presentation request to the information providing server 10 according to a user manipulation in a predetermined web page. When the reception unit 16 receives the presentation request, the reception unit 16 transmits, to the selection unit 18, a user ID for identifying the user of the user terminal T, which is a transmission source, and presentation request information indicating the fact that the reception unit 16 has received the presentation request.

The selection unit 18 is a means which selects one or more pieces of question information from among a plurality of pieces of question information stored in the question information storage unit 14. In order to divide a set of quizzes including a predetermined number of questions several times and present the quizzes to the user, the selection unit 18 selects some of the set of quizzes in response to one presentation request. The selection unit 18 may select only one piece of question information or may select a plurality of pieces of question information. For example, the selection unit 18 may select only one, two, or five pieces of question information in response to one presentation request in order to present a set of quizzes of ten questions to the user. The selection unit 18 transmits the selected question information to the transmission unit 20.

Further, the selection unit 18 generates answer information indicating a question status and an answer status for the user who has requested the quiz, and stores the answer information in the answer information storage unit 22. A storage timing of the answer information in this selection unit 18 may be a timing at which the selected question is transmitted to the user terminal T. The answer information is information in which a user ID for identifying a user, a quiz ID corresponding to the question information selected by the selection unit 18, and a status of an answer to the quiz indicated by this quiz ID are at least associated. In the present embodiment, the answer information includes the user ID, the quiz ID, an answer status flag indicating whether the user has answered, a true and false flag indicating whether the answer is true or false, and answer date and time.

The selection unit 18 selects a quiz to be currently presented to the user based on answer information on quizzes presented to the user in the past. This selection method will be described below.

The transmission unit 20 is a means which transmits a quiz indicated by the question information selected by the selection unit 18 to the user terminal T. The transmission unit 20 transmits information including the question of the quiz indicated by the question information to the user terminal T as an HTTP response to the presentation request of the user terminal T. Further, the transmission unit 20 outputs the question information selected by the selection unit 18 to the true and false determination unit 24.

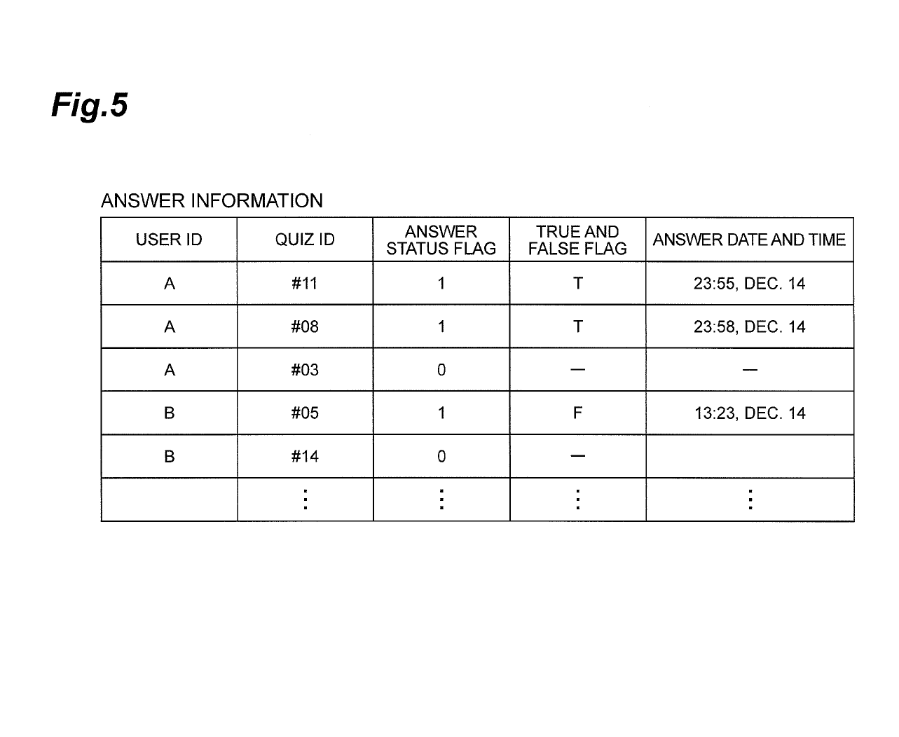

The answer information storage unit 22 is a means which stores the answer information. An example of the answer information is illustrated in FIG. 5. In an answer status flag, “1” indicates that the answer of the quiz has been received and “0” indicates that the answer of the quiz has not been received. In a true and false flag, “T” indicates that the quiz is answered correctly, and “F” indicates that the answer is an incorrect answer. Further, in the true and false flag, “-” indicates Unanswered. An initial value of the answer status flag is “0” and an initial value of the true and false flag is “-.”

The answer information illustrated in FIG. 5 indicates that quizzes indicated by quiz IDs “#11,” “#08” and “#03” (hereinafter referred to as “quiz #11,” “quiz #08” and “quiz #03,” respectively) are transmitted to a user corresponding to user ID “A” (hereinafter simply referred to as “user A”). The answer information also indicates that answers to quizzes #11 and #08 are received on “23:55, December 14” and “23:58, December 14” from user A, respectively, and an answer to quiz #03 has not been received. The answer information also indicates that the user A correctly answers quizzes #11 and #08, and does not answer quiz #03. The question and answer status is stored in the same way for a user of user ID “B.”

The true and false determination unit 24 is a means which determines whether the answer of the user received by the reception unit 16 is true or false. The true and false determination unit 24 compares the answer of the user received by the reception unit 16 with the correct answer of the question information output from the transmission unit 20, determines that the answer of the user is a correct answer if the answers match and determines that the answer of the user is an incorrect answer if the answers do not match. The true and false determination unit 24 updates the true and false flag of the answer information in the answer information storage unit 22 specified by the user ID of the user, based on a determination result. In other words, the true and false determination unit 24 sets the true and false flag of the answer information to “T” if the answer of the user is a correct answer and sets the true and false flag of the answer information to “F” if the answer of the user is an incorrect answer. Further, the true and false determination unit 24 updates the answer status flag and the answer date and time of the answer information to “1” and current date and time. An update timing in the true and false determination unit 24 may be a timing at which the answer from the user terminal T is received. When the answer information is updated in this way, the true and false determination unit 24 outputs the question information, and true and false information indicating whether the answer of the user is true or false to the result transmission unit 26.

The result transmission unit 26 is a means which transmits an answer result of the user for the quiz transmitted by the transmission unit 20. The result transmission unit 26 transmits information indicating whether the answer is true or false to the quiz of the user, and the correct answer of the quiz to the user terminal T based on the question information and the true and false information output from the true and false determination unit 24.

Next, a procedure in which the selection unit 18 selects one or more pieces of question information from the question information storage unit 14 will be described. When the selection unit 18 receives presentation request information from the reception unit 16, the selection unit 18 extracts answer information corresponding to a user ID included in the presentation request information from the answer information storage unit 22. When no answer information can be extracted, that is, when the user requests a set of quizzes for the first time, the selection unit 18 selects the question information on some of one set of quizzes from the question information storage unit 14. Further, a method of selecting the question information is not limited. For example, the selection unit 18 may also randomly select the question information. If a question order of the quiz is determined in advance, the selection unit 18 may select the question information according to the order.

On the other hand, when the number of extracted records is equal to or more than 1, that is, when the user makes a second or subsequent request for a set of quizzes, the selection unit 18 determines whether there is the answer information whose answer status flag is set to “0” among the extracted answer information. Also, when there is such answer information, the selection unit 18 selects question information corresponding to the quiz ID indicated by the answer information from the question information storage unit 14. In this case, the selected question information indicates a quiz which has been transmitted to the user in the past but whose answer has not been received. On the other hand, when there is no answer information whose answer status flag has been set to “0,” the selection unit 18 selects the question information from the question information storage unit 14 at random or according to the question order.

The batch processing execution unit 28 is a means which executes batch processing for deleting the answer information in the answer information storage unit 22 according to a predetermined schedule. In the present embodiment, the user is given a chance to answer a set of quizzes only once a day, and in order to realize such a system, the batch processing execution unit 28 executes the batch processing once a day. An example of the batch processing is shown below.

As an example, the batch processing execution unit 28 may also delete all answer information unconditionally at a predetermined execution time. In this case, the user cannot challenge one set of quizzes in a day.

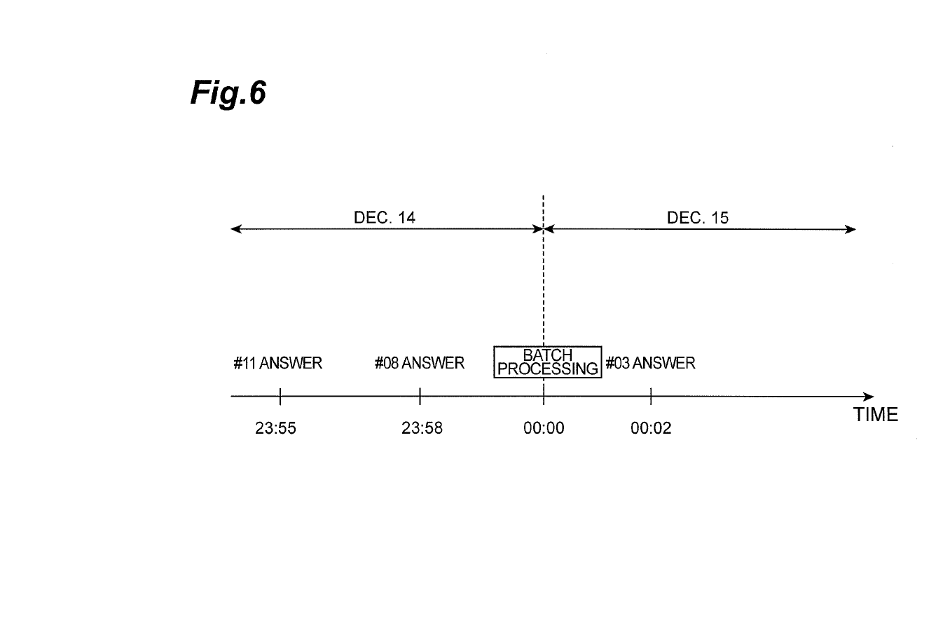

Such a phenomenon will be described with reference to FIG. 6. FIG. 6 illustrates a sequential relationship between a quiz answer time of user A illustrated in FIG. 5 and batch processing in the batch processing execution unit 28. In this example, it is assumed that the batch processing execution unit 28 starts up at 00:00 a.m. once a day and deletes all answer information stored in the answer information storage unit 22. Meanwhile, user A is assumed to answer quiz #11, quiz #08 and quiz #03 at 23:55 on December 14, 23:58 on December 14 and 0:02 on December 15. In this example, when user A answers quiz #03, the batch processing is executed and all answer information is deleted. Accordingly, the information providing server 10 cannot update the true and false flag and cannot receive the answer.

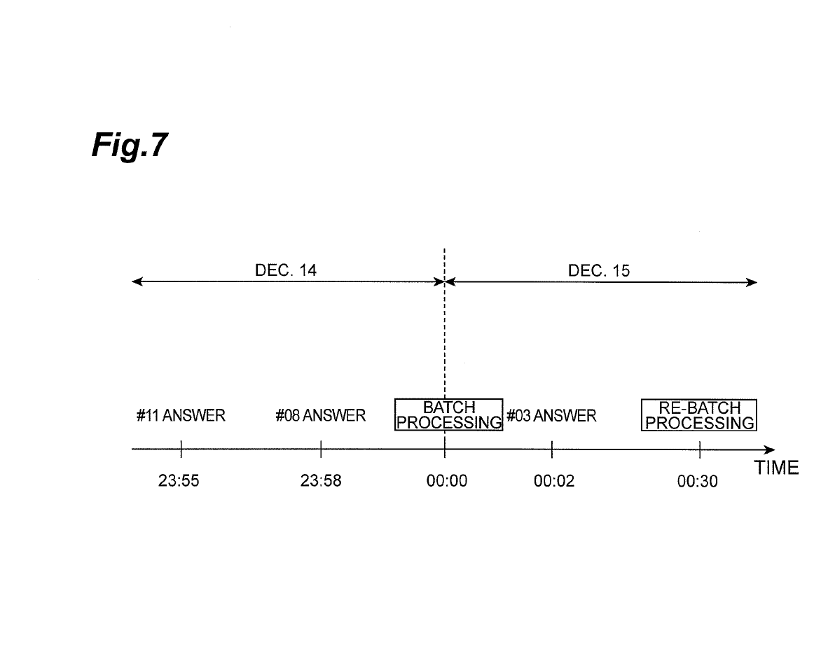

Therefore, if an initial answer time indicated by the answer information for a set of quizzes for a certain user is within a predetermined time before the execution time, the batch processing execution unit 28 may not delete the answer information for the user. FIG. 7 illustrates an example in which the answer information for user A is not deleted when the initial answer time of user A is within 30 minutes before the execution time. In the example of FIG. 7, the initial answer time of user A is 23:55 at which quiz #11 is answered and is within 30 minutes before 00:00 a.m. which is the execution time. In this case, the batch processing execution unit 28 does not delete the answer information for user A. The batch processing execution unit 28 then performs the batch processing again after a predetermined time (in this example, 30 minutes) elapses, and deletes the answer information for user A which has not been deleted in the initial batch processing.

Alternatively, if a last answer time indicated by the answer information for one set of quizzes for a certain user is within a predetermined time before the execution time, the batch processing execution unit 28 may not delete the answer information for the user. For example, when the last answer time of the user is within three minutes before the execution time, the batch processing execution unit 28 does not delete the answer information for the user. In the example of FIG. 7, the last answer time of user A is 23:58 at which quiz #08 is answered and is within three minutes before 00:00 a.m. which is the execution time. In this case, the batch processing execution unit 28 does not delete the answer information for user A. The batch processing execution unit 28 then performs the batch processing again after a predetermined time (in this example, 30 minutes) elapses, and deletes the answer information for user A which has not been deleted in the initial batch processing.

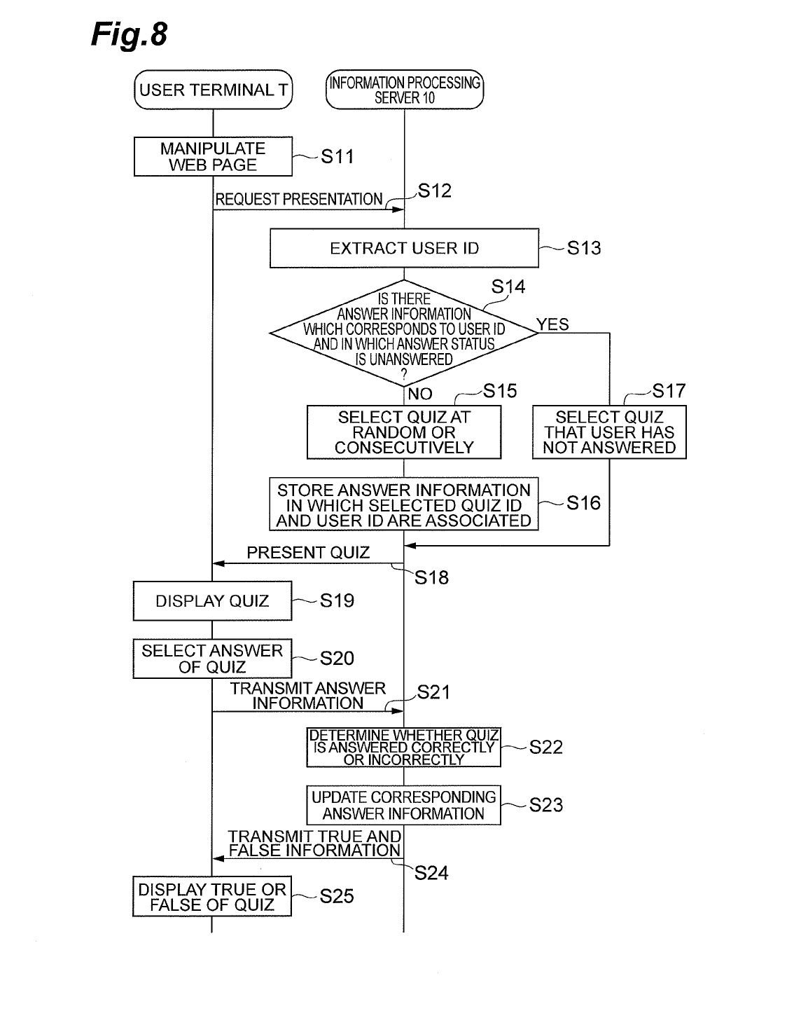

Next, operation of the system illustrated in FIG. 1 will be described with reference to FIG. 8 and the information providing method according to the present embodiment will be described.

A user accessing a predetermined website is interested in a quiz provided in the website and desires presentation of the quiz. First, the user performs a predetermined manipulation (e.g., pressing of a “quiz challenge” button or a manipulation for proceeding to a next quiz) in a web page using the user terminal T (step S11) and transmits a presentation request to the information providing server 10 (step S12).

In the information providing server 10, the reception unit 16 receives the quiz presentation request and extracts a user ID of the user terminal T (step S13). The selection unit 18 then determines whether there is answer information which corresponds to the user ID and in which an answer status is Unanswered by referring to the answer information storage unit 22 (step S14).

When there is no answer information (step S14; NO), the selection unit 18 selects a quiz from the question information storage unit at random or consecutively (step S15), generates answer information in which a quiz ID of the quiz and a user ID are associated, and stores the answer information in the answer information storage unit 22 (step S16). On the other hand, when there is answer information which corresponds to the user ID and in which the answer status is Unanswered (step S14: YES), the selection unit 18 selects a quiz corresponding to the quiz ID of the answer information, i.e., a quiz that the user has not yet answered (step S17).

The transmission unit 20 then presents the quiz selected in step S15 or S17 to the user terminal T (step S18). The user terminal T displays a web page showing the received quiz (step S19). Then, when the user selects an answer of the quiz through the web page (step S20), the user terminal T transmits information indicating the answer to the information providing server 10 (step S21).

In the information providing server 10, the reception unit 16 receives the answer information. Also, the true and false determination unit 24 determines whether the quiz of the user is correctly answered by referring to the question information of the question information storage unit 14 (step S22) and updates the true and false flag and the answer time of the answer information according to a determination result (step S23). The information providing server 10 then transmits true and false information indicating whether the answer of the user is true or false to the user terminal T (step S24).

The user terminal T displays the true or false of the quiz on a screen based on the received true and false information (step S25). A series of processes described above is repeatedly executed until the user answers all of a set of quizzes. Thus, the information providing server 10 presents a next quiz to the user based on the situation of presentation of the quiz to the user and the answer status of the user.

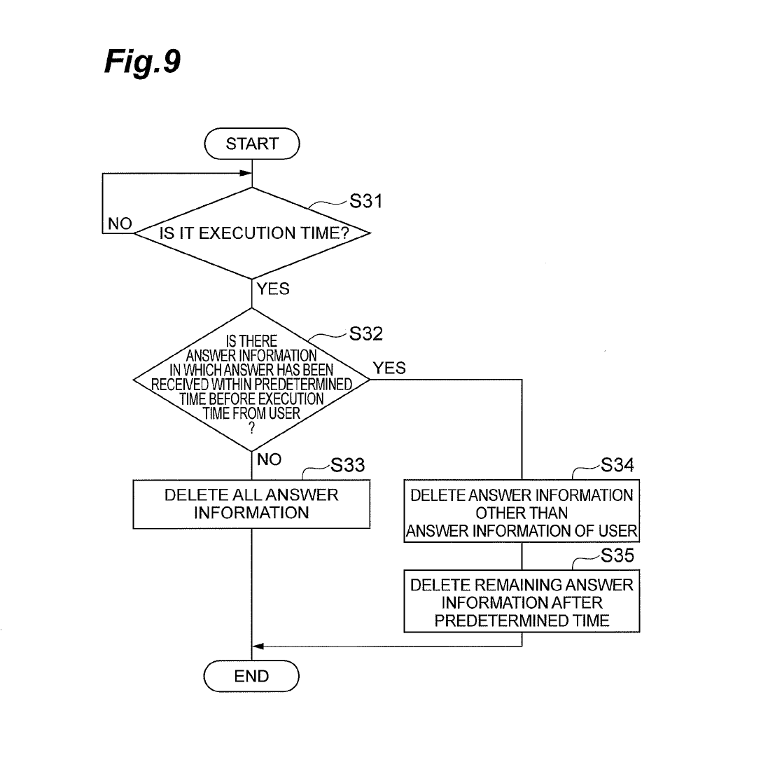

Next, operation of the batch processing in the batch processing execution unit 28 will be described with respect to FIG. 9. A series of processes illustrated in FIG. 9 is executed at predetermined time intervals.

The batch processing execution unit 28 waits until it is an execution time (e.g., 00:00 a.m.) (step S31: NO). When it is the execution time (step S31: YES), the batch processing execution unit 28 determines whether there is answer information in which an answer has been received within a predetermined time before the execution time from the user, by referring to the answer information storage unit 22 (step S32). As described above, the batch processing execution unit 28 performs this determination based on the initial answer time or the last answer time of the user.

When there is no such answer information (step S32: NO), the batch processing execution unit 28 deletes all answer information from the answer information storage unit 22 (step S33). On the other hand, when there is such answer information (step S32: YES), the batch processing execution unit 28 deletes answer information other than a set of answer information corresponding to the user ID included in the answer information, from the answer information storage unit 22 (step S34). Also, the batch processing execution unit 28 deletes remaining answer information from the answer information storage unit 22 after a predetermined time (step S35). When all the answer information is deleted from the answer information storage unit 22 in step S33 or S35, a series of batch processing ends.

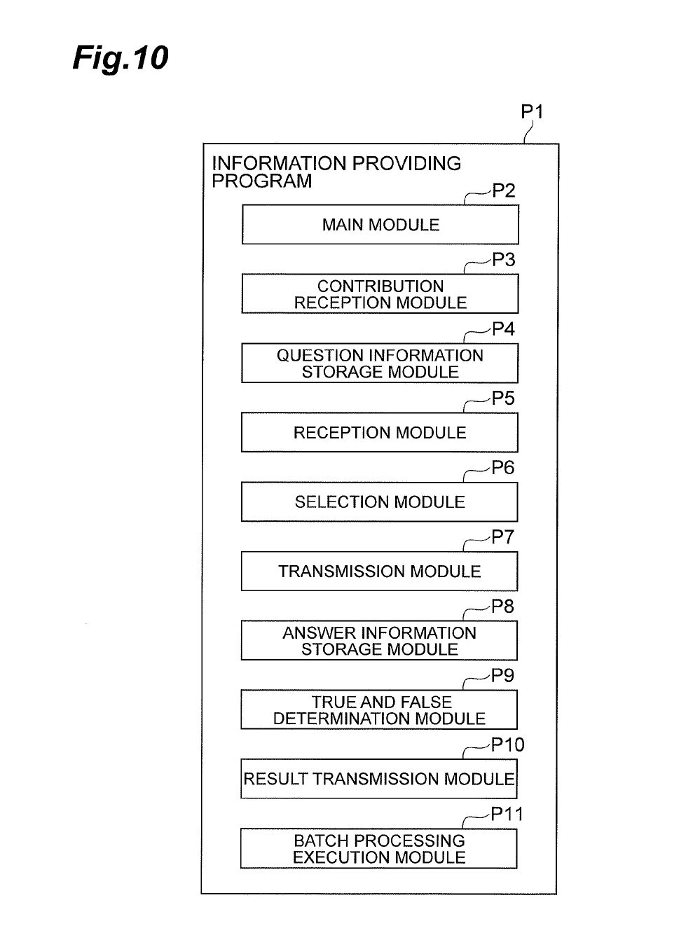

Next, an information providing program P1 for causing a computer to function as the information providing server 10 will be described with reference to FIG. 10.

The information providing program P1 includes a main module P2, a contribution reception module P3, a question information storage module P4, a reception module P5, a selection module P6, a transmission module P7, an answer information storage module P8, a true and false determination module P9, a result transmission module P10, and a batch processing execution module P11.

The main module P2 is a part which controls an overall information providing process (for presenting a question). Functions realized by executing the contribution reception module P3, the question information storage module P4, the reception module P5, the selection module P6, the transmission module P7, the answer information storage module P8, the true and false determination module P9, the result transmission module P10 and the batch processing execution module P11 are the same as functions of the contribution reception unit 12, the question information storage unit 14, the reception unit (presentation request reception unit; answer reception unit) 16, the selection unit 18, the transmission unit 20, the answer information storage unit 22, the true and false determination unit 24, the result transmission unit 26 and the batch processing execution unit 28, respectively.

The information providing program P1, for example, is recorded in a tangible recording medium such as a CD-ROM, a DVD-ROM, or a semiconductor memory, and then provided. Further, the information providing program P1 may be provided as a data signal superimposed on carrier waves via the network N.

As described above, according to the present embodiment, since next one or more quizzes are selected based on the answer information in which the quiz presented to the user and the answer status for this quiz are associated, it is possible to present the next quiz based on a situation of the quiz presentation to the user or an answer of the user.

Further, in the present embodiment, since the quizzes presented to the user and not yet answered by the user are selected as next one or more quizzes again, a chance to answer the quizzes can be given to the user. Further, even when the user sends a request to the information providing server 10 several times until an answerable quiz is displayed, the same quiz, i.e., an unanswered quiz is presented to the user again and accordingly it is possible to prevent an illegal act of such a user.

Further, in the present embodiment, since the answer information is generated when the quiz for the user is selected, and the answer situation flag of the answer information is updated to “1” when the answer to the quiz is received, the answer information can be accurately recorded according to a quiz or answer reception timing.

Further, in the present embodiment, when the user answers after a time point obtained by going back a predetermined period of time from execution date and time of a deletion process, the answer information for the user is held instead of being deleted. Therefore, it is possible to prevent a situation in which the associated answer information is deleted while the quiz is being answered. Specifically, it is possible to prevent the answer information from being deleted on the way even when the user begins to answer to a set of quizzes immediately before the execution date and time of the batch processing. Further, it is also possible to delete or hold the answer information in consideration of a timing at which a user has last answered a set of quizzes.

Further, in the present embodiment, if a predetermined time elapses from the execution date and time, the held answer information is deleted and accordingly all the answer information can be deleted without giving a disadvantage to a user.

The present invention has been described above in detail based on the embodiments thereof. However, the present invention is not limited to the above embodiments. Various modifications may be made to the present invention without departing from the gist of the present invention.

In the above embodiment, while the information providing server 10 includes the storage unit, this storage unit may be provided in a server other than the information providing server 10. Further, the functions of the contribution reception unit and the batch processing execution unit may be provided in a server other than the information providing server 10.

In the above embodiment, while the answer information includes the user ID, the quiz ID, the answer status flag, the true and false flag, and the answer date and time, some of these items may be omitted or different items from these items may be included. For example, if a premium is provided when eight quizzes among ten quizzes are correctly answered, counter information obtained by counting the number of correct answers of each user may be included. Further, while the answer information includes the answer date and time, the information providing server 10 may store date and time on which the quiz has been transmitted. Further, if the batch processing execution unit unconditionally deletes the answer information, the answer date and time may be omitted.

In the above embodiment, while the selection unit 18 stores new answer information in the answer information storage unit 22, the transmission unit 20 may store the answer information in the answer information storage unit 22 when the transmission unit 20 transmits the quiz to the user terminal T.

If quizzes are presented in a predetermined order rather than at random, only one record for the answer information may be generated per user. In this case, the answer information includes a user ID, a quiz ID of a last quiz presented to a user, an answer status flag for the quiz, a total number of presented quizzes, a number of correct answers, and answer date and time. In this case, the selection unit may select a quiz to be presented next, as in the above embodiment.

The question presented by the information providing server is not limited to the quiz and may be other types of questions such as questionnaires requiring an answer. The present invention may be applied to any question requiring an answer.

In the above embodiment, while exchange of data between the information providing server 10 and the user terminal T, such as a presentation request, answer transmission or the like, is performed through HTTP, the data exchange may be performed using other means such as E-mail.

Further, in the above embodiment, while the selection unit 18 divides a set of quizzes including a predetermined number of questions any number of times and then presents the quizzes to the user, the quizzes need not be necessarily divided any number of times and then presented to the user and may be presented to the user only once.

### REFERENCE SIGNS LIST

1 . . . Information providing system, 10 . . . Information providing server, 12 . . . Contribution reception unit, 14 . . . Question information storage unit, 16 . . . Reception unit, 18 . . . Selection unit (storage unit), 20 . . . Transmission unit, 22 . . . Answer information storage unit, 24 . . . True and false determination unit (updating unit), 26 . . . Result transmission unit, 28 . . . Batch processing execution unit, P1 . . . Information providing program, P2 . . . Main module, P3 . . . Contribution reception module, P4 . . . Question information storage module, P5 . . . Reception module, P6 . . . Selection module, P7 . . . Transmission module, P8 . . . Answer information storage module, P9 . . . True and false determination module, P10 . . . Result transmission module, P11 . . . Batch processing execution module

1. An information providing device comprising:
a presentation request reception unit which receives a presentation request for a question requiring an answer from a terminal of a user;
a selection unit which selects, after receiving the presentation request, one or more questions from a question information storage unit which stores question information relating to a plurality of questions without determining an order in advance, each piece of question information including one question and a question ID for identifying the question;
a transmission unit which transmits the one or more questions selected by the selection unit to the terminal;
an answer reception unit which receives answers to the one or more questions transmitted by the transmission unit from the terminal;
a storage unit which stores answer information in which a user ID for identifying the user, one or more question IDs corresponding to the one or more questions, and an answer status indicating presence or absence of the answers to the one or more questions are associated, in an answer information storage unit, at a timing at which the questions selected by the selection unit are transmitted to the terminal of the user; and
an updating unit which updates the answer status associated with the user ID for identifying the user and the question ID into an answered state at a timing at which the answers to the transmitted one or more questions are received from the terminal of the user,
wherein when there is answer information which includes the user ID and in which the answer status is an unanswered state in the answer information storage unit, the selection unit selects questions corresponding to the question IDs of the answer information as next one or more questions.

2. The information providing device according to claim 1, further comprising a batch processing execution unit which deletes the answer information stored in the answer information storage unit on predetermined execution date and time,
wherein date and time on which answers to the one or more questions are received is further associated as answer date and time in the answer information, and
when the answer information which corresponds to the user ID and in which date and time on which the answer has been received is within a predetermined time before the execution date and time is stored in the answer information storage unit, the batch processing execution unit does not delete the answer information for the user ID.

3. The information providing device according to claim 2, wherein the answer date and time is date and time on which the answers to the one or more questions initially transmitted to the terminal among the plurality of questions are received.

4. The information providing device according to claim 2, wherein the answer date and time is date and time on which the answers to the one or more questions last transmitted to the terminal among the plurality of questions are received.

5. The information providing device according to claim 2, wherein the batch processing execution unit deletes the answer information for the user ID which has not been deleted on the execution date and time when a predetermined time elapses from the execution date and time.

6. An information providing method comprising:
a presentation request reception step of receiving a presentation request for a question requiring an answer from a terminal of a user;
a selection step of selecting, after receiving the presentation request, one or more questions from a question information storage unit which stores question information relating to a plurality of questions without determining an order in advance, each piece of question information including one question and a question ID for identifying the question;
a transmission step of transmitting the one or more questions selected in the selection step to the terminal;
an answer reception step of receiving answers to the one or more questions transmitted in the transmission step from the terminal;
a storage step of storing answer information in which a user ID for identifying the user, one or more question IDs corresponding to the one or more questions, and an answer status indicating presence or absence of the answers to the one or more questions are associated, in an answer information storage unit, at a timing at which the questions selected in the selection step are transmitted to the terminal of the user; and
an updating step of updating the answer status associated with the user ID for identifying the user and the question ID into an answered state at a timing at which the answers to the transmitted one or more questions are received from the terminal of the user,
wherein, when there is answer information which includes the user ID and in which the answer status is an unanswered state in the answer information storage unit, questions corresponding to the question IDs of the answer information are selected as next one or more questions in the selection step.

7. (canceled)

8. A non-transitory computer-readable recording medium having an information providing program recorded thereon, wherein the information providing program causes a computer to function as:
a presentation request reception unit which receives a presentation request for a question requiring an answer from a terminal of a user;
a selection unit which selects, after receiving the presentation request, one or more questions from a question information storage unit which stores question information relating to a plurality of questions without determining an order in advance, each piece of question information including one question and a question ID for identifying the question;
a transmission unit which transmits the one or more questions selected by the selection unit to the terminal;
an answer reception unit which receives answers to the one or more questions transmitted by the transmission unit from the terminal;
a storage unit which stores answer information in which a user ID for identifying the user, one or more question IDs corresponding to the one or more questions, and an answer status indicating presence or absence of the answers to the one or more questions are associated, in an answer information storage unit, at a timing at which the questions selected by the selection unit are transmitted to the terminal of the user; and
an updating unit which updates the answer status associated with the user ID for identifying the user and the question ID into an answered state at a timing at which the answers to the transmitted one or more questions are received from the terminal of the user,
wherein when there is answer information which includes the user ID and in which the answer status is an unanswered state in the answer information storage unit, the selection unit selects questions corresponding to the question IDs of the answer information as next one or more questions.

9. The information providing device according to claim 3, wherein the batch processing execution unit deletes the answer information for the user ID which has not been deleted on the execution date and time when a predetermined time elapses from the execution date and time.

10. The information providing device according to claim 4, wherein the batch processing execution unit deletes the answer information for the user ID which has not been deleted on the execution date and time when a predetermined time elapses from the execution date and time.
